(19) United States
(12) Patent Application Publication
(10) Pub. No.: US 2021/0225366 A1
(43) Pub. Date: Jul. 22, 2021

(54) SPEECH RECOGNITION SYSTEM WITH FINE-GRAINED DECODING

(71) Applicant: British Cayman Islands Intelligo Technology Inc., Hsinchu County (TW)

(72) Inventors: Ting-Yao CHEN, Hsinchu County (TW); Chun-Hung CHEN, Hsinchu County (TW); Chen-Chu HSU, Hsinchu County (TW); Tsung-Liang CHEN, Hsinchu County (TW)

(21) Appl. No.: 17/137,447

(22) Filed: Dec. 30, 2020

Related U.S. Application Data
(60) Provisional application No. 62/961,720, filed on Jan. 16, 2020.

(51) Int. Cl. G10L 15/08; G10L 15/02; G10L 15/14; G10L 15/30

(52) U.S. Cl. CPC G10L 15/08; G10L 15/02; G10L 15/142; G10L 2015/022; G10L 2015/088; G10L 2015/025; G10L 15/30

(57) ABSTRACT

Provided is a speech recognition system including an acoustic model, a decoding graph module, a history buffer, and a decoder. The acoustic model is configured to receive an acoustic input from an input module, divide the acoustic input into audio clips, and return scores evaluated for the audio clips. The decoding graph module is configured to store a decoding graph having at least one possible path of the keyword. The history buffer is configured to store history information corresponding to the possible path in the decoding graph module. The decoder is connected to the acoustic model, the decoding graph module, and the history buffer, and configured to receive the scores from the acoustic model, loop up the possible path in the decoding graph module, and predict an output keyword.

### CROSS REFERENCE TO RELATED APPLICATION

This application claims the benefit of filing date of U.S. Provisional Application Ser. No. 62/961,720, entitled “Fine-Grained Decoding in Speech Recognition Systems” filed Jan. 16, 2020 under 35 USC § 119(e)(1).

### BACKGROUND OF THE INVENTION

### 1. Field of the Invention

The present invention relates to a speech recognition system, and more specifically, to a speech recognition system with fine-grained decoding.

### 2. Description of Related Art

In order for the users to interact with computers by their voices, speech recognition systems have been developed. The technology of speech recognition combines computer science and computational linguistics to identify the received voices, and it can realize various applications such as automatic speech recognition (ASR), natural language understanding (NLU), or speech to text (STT).

However, given the wide variety of words in different languages as well as various accents and pronunciations thereof, there is indeed a challenge in the realization of speech recognition.

When developing a speech recognition system, people concern much about its accuracy and speed. Among accuracy issues, vocabulary confusability is the prerequisite to be solved. For example, the phonemes “r” and “rr”, as well as “s” and “z”, in different vocabularies may be difficult to be distinguished, especially when a non-native speaker is involved.

Therefore, it is desirable to provide an improved speech recognition system.

### SUMMARY OF THE INVENTION

In spoken language analysis, an utterance is the smallest unit of speech. Given an input utterance, a speech recognition decoder is responsible for searching the most likely output word (or word sequence), and making a prediction therefrom. The output word may be accompanied with a confidence score which can be used to evaluate its likelihood.

According to the present invention, during decoding, for each node on a decoding graph, a symbol of a sub-word unit, a confidence score, a timestamp, and other useful information are correspondingly stored into an history buffer. When ending conditions of decoding are met, the decoder decides the output word (or word sequence) and the corresponding confidence score by traversing the history buffer. For example, the final confidence score may be given by accumulating scores for nodes on the best path of the final output word (or word sequence).

The aforementioned mechanism of the present invention is applicable to applications such as automatic speech recognition (ASR) system, keyword spotting (KWS) system, and so on.

The present invention provides a speech recognition system including an acoustic model, a decoding graph module, a history buffer, and a decoder. The acoustic model is configured to receive an acoustic input from an input module, divide the acoustic input into audio clips, and return scores evaluated for the audio clips. The decoding graph module is configured to store a decoding graph having at least one possible path of the keyword. The history buffer is configured to store history information corresponding to the possible path in the decoding graph module. The decoder is connected to the acoustic model, the decoding graph module, and the history buffer, and configured to receive the scores from the acoustic model, loop up the possible path in the decoding graph module, and predict an output keyword.

Other objects, advantages, and novel features of the invention will become more apparent from the following detailed description when taken in conjunction with the accompanying drawings.

### BRIEF DESCRIPTION OF THE DRAWINGS

FIG. 1 shows a schematic block diagram of the speech recognition system according to one embodiment of the present invention;

FIG. 2 shows a schematic diagram of a possible path of the decoding graph and its corresponding history information according to one embodiment of the present invention;

FIG. 3 shows a schematic diagram of keyword alignment application according to one embodiment of the present invention;

FIG. 4 shows a schematic diagram of exact keyword score application according to one embodiment of the present invention;

FIG. 5 shows a schematic diagram of a keyword in a slow tempo speech (a) at top and a keyword in a fast tempo speech (b) at bottom according to one embodiment of the present invention;

FIG. 6 shows a schematic diagram of grouping sub-word information application according to one embodiment of the present invention;

FIG. 7 shows a schematic diagram of garbage word rejection application according to one embodiment of the present invention; and

FIG. 8 shows a schematic diagram of multi-pass decoding application according to one embodiment of the present invention.

### DETAILED DESCRIPTION OF THE EMBODIMENT

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the element, except otherwise specified.

Moreover, in the present specification, the ordinal numbers, such as “first” or “second”, are used to distinguish a plurality of elements having the same name, and it does not means that there is essentially a level, a rank, an executing order, or an manufacturing order among the elements, except otherwise specified. A “first” element and a “second” element may exist together in the same component, or alternatively, they may exist in different components, respectively. The existence of an element described by a greater ordinal number does not essentially means the existent of another element described by a smaller ordinal number.

Moreover, in the present specification, the terms, such as “top”, “bottom”, “left”, “right”, “front”, “back”, or “middle”, as well as the terms, such as “on”, “above”, “under”, “below”, or “between”, are used to describe the relative positions among a plurality of elements, and the described relative positions may be interpreted to include their translation, rotation, or reflection.

Moreover, in the present specification, when an element is described to be arranged “on” another element, it does not essentially means that the elements contact the other element, except otherwise specified. Such interpretation is applied to other cases similar to the case of “on”.

Moreover, in the present specification, the terms, such as “preferably” or “advantageously”, are used to describe an optional or additional element or feature, and in other words, the element or the feature is not an essential element, and may be ignored in some embodiments.

Moreover, in the present specification, when an element is described to be “suitable for” or “adapted to” another element, the other element is an example or a reference helpful in imagination of properties or applications of the element, and the other element is not to be considered to form a part of a claimed subject matter; similarly, except otherwise specified; similarly, in the present specification, when an element is described to be “suitable for” or “adapted to” a configuration or an action, the description is made to focus on properties or applications of the element, and it does not essentially mean that the configuration has been set or the action has been performed, except otherwise specified.

Moreover, each component may be realized as a single circuit or an integrated circuit in suitable ways, and may include one or more active elements, such as transistors or logic gates, or one or more passive elements, such as resistors, capacitors, or inductors, but not limited thereto. Each component may be connected to each other in suitable ways, for example, by using one or more traces to form series connection or parallel connection, especially to satisfy the requirements of input terminal and output terminal. Furthermore, each component may allow transmitting or receiving input signals or output signals in sequence or in parallel. The aforementioned configurations may be realized depending on practical applications.

Moreover, in the present specification, the terms, such as “system”, “apparatus”, “device”, “module”, or “unit”, refer to an electronic element, or a digital circuit, an analogous circuit, or other general circuit, composed of a plurality of electronic elements, and there is not essentially a level or a rank among the aforementioned terms, except otherwise specified.

Moreover, in the present specification, two elements may be electrically connected to each other directly or indirectly, except otherwise specified. In an indirect connection, one or more elements, such as resistors, capacitors, or inductors may exist between the two elements. The electrical connection is used to send one or more signals, such as DC or AC currents or voltages, depending on practical applications.

Moreover, a terminal or a server may include the aforementioned element(s), or be implemented in the aforementioned manner(s).

Moreover, in the present specification, a value may be interpreted to cover a range within ±10% of the value, and in particular, a range within ±5% of the value, except otherwise specified; a range may be interpreted to be composed of a plurality of subranges defined by a smaller endpoint, a smaller quartile, a median, a greater quartile, and a greater endpoint, except otherwise specified.

(General Speech Recognition System with Fine-Grained Decoding)

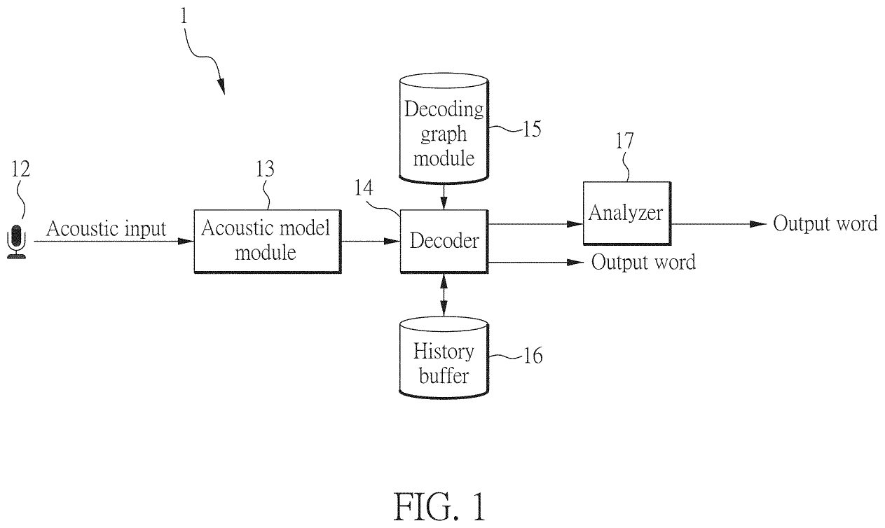

FIG. 1 shows a schematic block diagram of the speech recognition system 1 according to one embodiment of the present invention. The speech recognition system 1 may be implemented in a cloud server or in a local computing device.

The speech recognition system 1 mainly includes an acoustic model module 13, a decoder 14, a decoding graph module 15, and a history buffer 16. There is an input module 12 usually separated from the speech recognition system 1, and an analyzer 17 being an optional component.

The input module 12 may be a microphone or a sensor to receive analogous acoustic input (e.g. speech, music, or other sounds) from the real world, or a data receiver to receive digital acoustic input (e.g. audio files) via wired or wireless data transmission. The received acoustic input is then sent into the acoustic model module 13.

The acoustic model module 13 may be trained by training data in association with words, phonemes, syllables, tri-phones, or other suitable linguistic units, and thus have a trained model based on a Gaussian mixture model (GMM), a neural network (NN) model, or other suitable modules. The trained model may have some states, such as hidden Markov model states, formed therein. The acoustic model module 13 can divide the received acoustic input into audio clips. For example, each audio clip may have a time duration of 10 milliseconds, but not limited thereto. Then, the acoustic model module 13 can analyze the audio clips based on its trained model, and accordingly return scores evaluated for the audio clips. For example, if there are m audio clips, and n possible results, the acoustic model module 13 generally generates m×n scores among them.

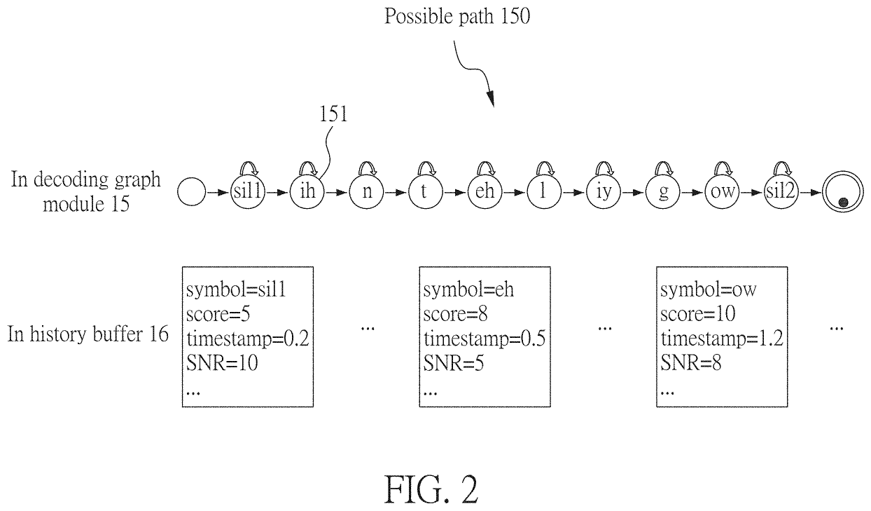

The decoding graph module 15 stores a decoding graph having one or more possible paths to give the prediction. The decoding graph module may be implemented as a finite-state transducer (FST). A possible path may be expressed as a chain of nodes. For example, as shown in FIG. 2, the possible path may be composed of phonemes “ih”, “n”, “t”, “eh”, “l”, “iy”, “g”, and “ow” for the word “intelligo”.

The history buffer 16 stores history information corresponding to the possible paths in the decoding graph module 15. The details of the history information will be explained later in the following description.

The decoder 14 is connected to the acoustic model 13, the decoding graph module 15, and the history buffer 16. The decoding graph module 15 and the history buffer 16 serve as databases that provide parameters to facilitate the fine-grained decoding in the decoder 14, as will be explained later in the following description in connection with various applications. The decoder 14 receives the processed result, e.g. the scores evaluated for the audio clips by the acoustic model 13, looks up the possible path in the decoding graph module 15, and preferably refers to the history information in the history buffer 16, so as to perform the decoding. When ending conditions of decoding are met, the decoder 14 outputs output word according to its prediction.

(Decoding Graph)

FIG. 2 shows a schematic diagram of a possible path 150 of the decoding graph and its corresponding history information according to one embodiment of the present invention.

As shown in FIG. 2, the best path 150 in the decoding graph is expressed as a chain of nodes 151 storing the sub-word units. (It is noted that in FIG. 2, only one node is labeled as “151” for clearness of the drawing.) Each sub-word unit is a phoneme. In phonology and linguistics, a phoneme is a minimal unit of sound that distinguishes one word from another in a particular language.

Let “intelligo” be a wakeup keyword, for example. The keyword “intelligo” is phonetized into “ih”, “n”, “t”, “eh”, “I”, “iy”, “g”, and “ow”, and orderly put into the nodes 151. Also in FIG. 2, the symbols “sil1” and “sil2” respectively represent the silences at the beginning and the end of the word, and the term “silence” substantially means a state without recognizable sound (perhaps with a small noise).

History information for each node includes a symbol of the sub-word unit, a confidence score (“score” for short), a timestamp, and a signal-to-noise ratio (SNR), but not limited thereto. Other information, such as amplitude, wavelength, or frequency of each sub-word unit, may also be stored in the history buffer 16.

For example, the node of the symbol “sil” at the beginning corresponds to a confidence score=5 points, a timestamp=0.2 seconds, and an SNR=10 dB.

The node of the symbol “eh” corresponds to a confidence score=8 points, a timestamp=0.5 seconds, and an SNR=5 dB.

The node of the symbol “ow” corresponds to a confidence score=10 points, a timestamp=1.2 seconds, and an SNR=8 dB.

Since the keyword is divided into the plural phonemes (put into the nodes), the respective phonemes are evaluated by their respective confidence scores, and they allow detailed analyses for making the prediction. For example, a total summation of all the confidence scores of the nodes can be used for the decoder 14 to decide the output word. Or alternatively, regional summation of the confidence scores of some adjacent nodes can be used for the decoder 14 to decide the output word.

(Keyword Alignment)

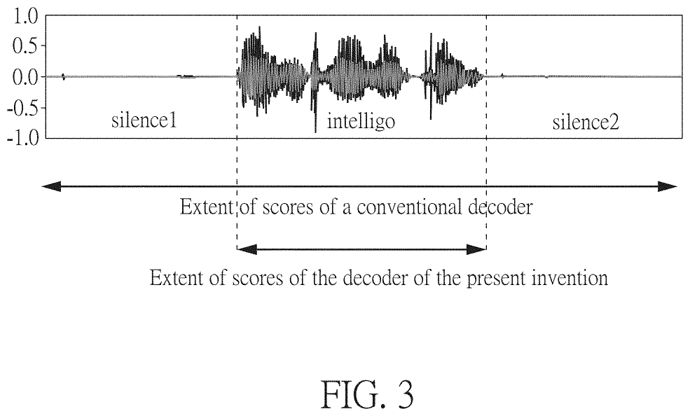

FIG. 3 shows a schematic diagram of keyword alignment application according to one embodiment of the present invention. In FIGS. 3-5 and 7-8, the vertical axis represents the amplitude of the waveform of the audio clip of the keyword, and the horizontal axis represents the time.

Following the description relevant to FIG. 2, since the symbol of the sub-word unit and its timestamp are recorded in the history buffer 16, after the decoder 14 accomplishes its speech recognition, keyword alignment information can be generated based on the timestamps of the nodes 151, and becomes a part of the history information in the history buffer 16.

With the keyword alignment information, it is possible for the decoder 14 of the present invention to analyze the temporal distribution of the sub-word units of the keyword, which is helpful in the decoding.

It is also possible for the decoder 14 of the present invention to recognize the keyword itself without waiting for the silences at the beginning and the end of the keyword. As shown in FIG. 3, the conventional decoder requires an extent of scores including “silence1” at the beginning and “silence2” at the end. Competitively, the decoder 14 of the present invention only requires a shorter extent of scores of the sub-word units of the keyword itself

(Exact Keyword Score)

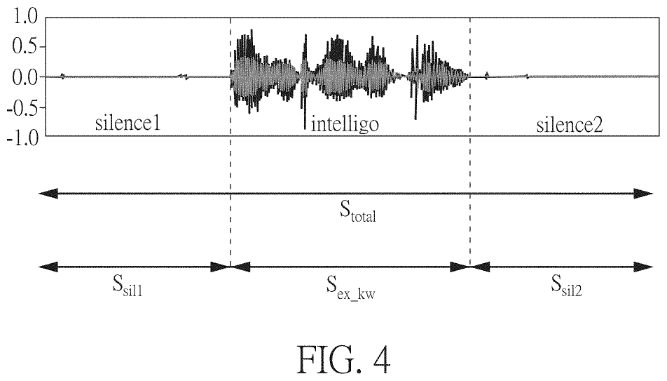

FIG. 4 shows a schematic diagram of exact keyword score application according to one embodiment of the present invention.

Since the history buffer 16 stores the history information regarding the scores of the respective parts (or nodes) of the audio of the keyword, an “exact keyword score” of the present invention can be derived by the following equation:

S_{ex_kw}=Sₜₒₜₐₗ−Sₛᵢₗ₁−Sₛᵢₗ₂

where S_{ex_kw} represents the exact keyword score (excluding the silence parts), Sₜₒₜₐₗ represents the keyword score (including the silence parts), Sₛᵢₗ₁ represents the silence1 score, and Sₛᵢₗ₂ represents the silence2 score.

In comparison, the conventional decoder generates a score including the contributions of the silence parts before and after the keyword, but the scores of the silence parts do not positively but may negatively affect the accuracy for determining the output keyword. Contrarily, the exact keyword score application of the present invention excludes the scores of the silence parts and focuses on the scores of the keyword itself, and thus can improve the accuracy for determining the output keyword.

(Keyword Score Normalization)

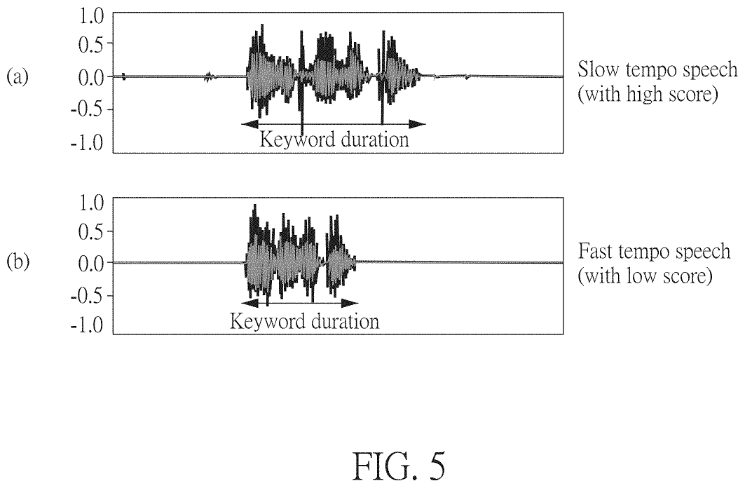

FIG. 5 shows a schematic diagram of a keyword in a slow tempo speech (a) at top and a keyword in a fast tempo speech (b) at bottom according to one embodiment of the present invention.

People may speak in a slow tempo or a fast tempo. However, the conventional decoder is typically accumulative, and therefore, a slow tempo speech tends to have a higher score than a fast tempo speech. Such accumulative evaluation may lead to an incorrect prediction, and is not preferable, especially in a KWS system.

Following the description relevant to FIG. 2, since the symbol of the sub-word unit and its timestamp are recorded in the history buffer 16, it is also possible to measure the keyword duration. The keyword duration cooperating with the keyword alignment can realize the keyword score normalization, so that the keyword score depends much less on the speaking tempo.

According to the present invention, a “normalized exact keyword score” can be derived by the following equation:

$${S}_{norm \_ kw} = \frac{{S}_{e {x}_{-} kw}}{{D}_{e {x}_{-} kw}}$$

where S_{norm_kw} represents the normalized exact keyword score, S_{ex_kw} represents the aforementioned exact keyword score, and D_{ex_kw} represents the exact keyword duration.

(SNR-Based Score Normalization)

Following the description relevant to FIG. 2, since the symbol of the sub-word unit and its signal-to-noise (SNR) ratio are recorded in the history buffer 16, the SNR ratio can be normalized with respect to the noisy level in the surrounding environment.

According to one embodiment of the present invention, an “overall normalized SNR score” can be derived by the following equation:

$${S}_{o {verall}_{-} n o r {m}_{-} s n r} = \frac{{S}_{ex \_ kw}}{S N {R}_{{avg \_ ex}_{-} kw}}$$

where S_{overall_norm_snr} represents the overall normalized SNR score, S_{ex_kw} represents the aforementioned exact keyword score, and SNR_{avg_ex_kw} represent the average SNR measured in the exact keyword duration.

According to another embodiment of the present invention, a “regional normalized SNR score” can be derived by the following equation:

$${S}_{regional \_ norm \_ snr} = {\sum }_{i} \frac{{S}_{sub - word \_ i}}{S N {R}_{sub - word \_ i}}$$

where S_{regional_norm_snr} represents the regional normalized SNR score, S_{sub-word_i} represents the i-th sub-word unit score, SNR_{sub-word_i} represents the SNR measured in the i-th sub-word unit duration, and Σ represents the summation operation.

A keyword score having higher SNR or a sub-word unit score having higher SNR are deemed more reliable in common cases, and can be helpful in making the prediction.

(Grouping Sub-Word Information)

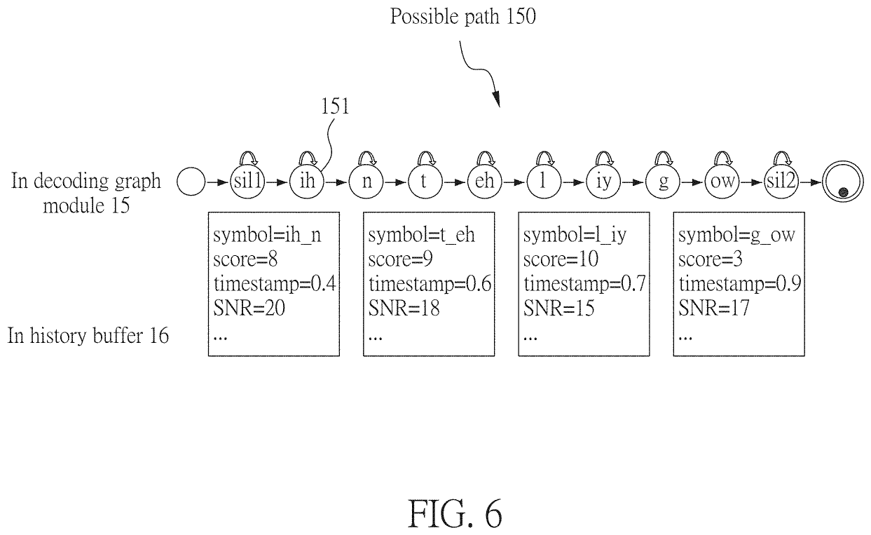

FIG. 6 shows a schematic diagram of grouping sub-word information application according to one embodiment of the present invention.

Even if a keyword is segmented into phonemes, and the phonemes are put into the nodes 151 of the chain which expresses the possible path in the decoding graph, the history information of the keyword may alternatively be arranged based on syllables rather than phonemes. A syllable is a unit of organization for a sequence of speech sounds. In the present invention, one or more phonemes may form a syllable. For example, The keyword “intelligo” is phonetized into “ih”, “n”, “t”, “eh”, “^{1”,} “iy”, “g”, and “ow”, and syllabized into “ih_n”, “t_eh”, “l_iy”, and “g_ow”.

The aforementioned keyword alignment application, exact keyword score application, keyword score normalization, and SNR-based score normalization is also applicable to the grouping sub-word information application with keyword syllabication.

(Garbage Word Rejection)

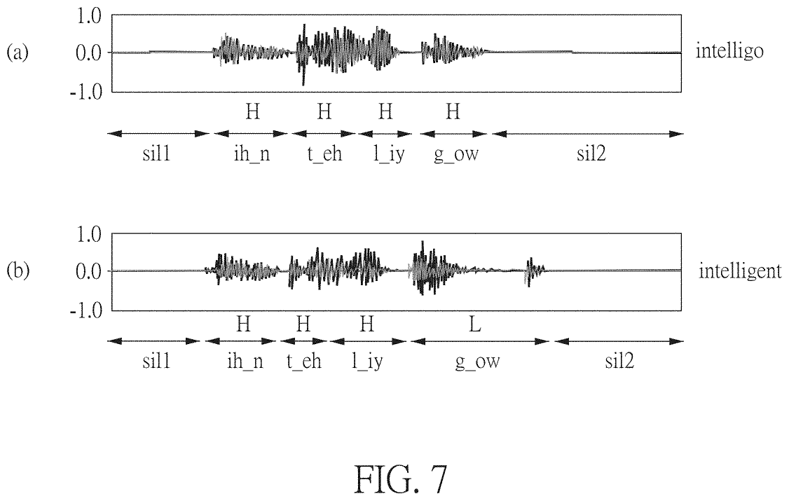

FIG. 7 shows a schematic diagram of garbage word rejection application according to one embodiment of the present invention.

The conventional decoder is typically accumulative, and therefore, there is a certain probability that a similar word (b), e.g. “intelligent”, has a higher total score than the total score of the correct wakeup keyword (a), e.g. “intelligo”, and thus triggers a false positive prediction. The similar words are known as garbage words.

The aforementioned exact keyword score application and grouping sub-word information application of the present invention can be used to reject such garbage words. For example, the decoder 14 can accept “intelligo” because all of the sub-word units of the word “intelligo” are determined to have high confidence scores, but reject “intelligent” because one sub-word unit “gent” of the word “intelligent” is determined to have a low confidence score with respect to “go_w”. In other words, the rejection may be made depending on one sub-word unit score. Accordingly, the present invention can improve the accuracy for determining the output keyword.

(Multi-Pass Decoding)

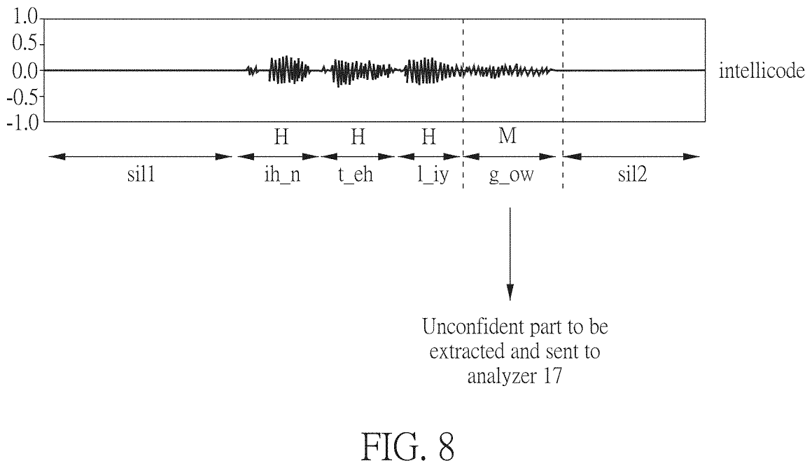

FIG. 8 shows a schematic diagram of multi-pass decoding application according to one embodiment of the present invention, wherein a garbage word “intellicode” including a sub-word unit “code” evaluated with a medium level score with respect to “g_ow”.

Referring back to FIG. 1, a keyword spotting decoder 14 usually has a simplified function than a full function speech detection analyzer 17, and is dedicated to deal with a specific wakeup keyword, in consideration of computational resource distribution.

However, a multi-pass decoding may be realized by combining the keyword spotting decoder 14 as a primary stage and the full function speech detection analyzer 17 as a secondary stage. Further according to the present invention, the confidence score may be graded into a high level (marked by “H”), a medium level (marked by “M”), and a low level (marked by “L”), for convenience. When one or more sub-word unit scores lie in or below the medium level, which means that the primary stage is not very confident for its prediction, the data (e.g. the audio clips) containing the unconfident sub-word units may be extracted and sent to the secondary stage which provides detailed analysis on the whole utterance containing the unconfident sub-word. Then, the scores of the unconfident sub-word units contained in the utterance are overwritten by the secondary stage, so that the final prediction can be given.

Although the present invention has been explained in relation to its preferred embodiment, it is to be understood that many other possible modifications and variations can be made without departing from the spirit and scope of the invention as hereinafter claimed.

What is claimed is:

1. A speech recognition system comprising:
an acoustic model configured to receive an acoustic input from an input module, divide the acoustic input into audio clips, and return scores evaluated for the audio clips;
a decoding graph module configured to store a decoding graph having at least one possible path of the keyword;
a history buffer configured to store history information corresponding to the possible path in the decoding graph module; and
a decoder connected to the acoustic model, the decoding graph module, and the history buffer, and configured to receive the scores from the acoustic model, loop up the possible path in the decoding graph module, and predict an output keyword.

2. The speech recognition system of claim 1, wherein the decoder is configured to save the history information of the keyword in the history buffer.

3. The speech recognition system of claim 1, wherein the input module is a microphone, a sensor, or a data receiver.

4. The speech recognition system of claim 1, wherein the decoding graph module is implemented as a finite-state transducer (FST).

5. The speech recognition system of claim 1, wherein the scores returned by the acoustic model are based on phonemes, syllables, tri-phones, or other suitable linguistic units, or hidden Markov model states or other suitable model states.

6. The speech recognition system of claim 1, wherein the possible path in the decoding graph module is expressed as a chain of nodes.

7. The speech recognition system of claim 6, wherein the nodes store sub-word units composing the keyword, and the sub-word units are phonemes, syllables, tri-phones, or other suitable linguistic units, or hidden Markov model states or other suitable model states of the keyword.

8. The speech recognition system of claim 7, wherein the history information in the history buffer includes a score, and/or a timestamp, and/or a signal-to-noise ratio (SNR) for each node.

9. The speech recognition system of claim 8, wherein a beginning node stores a beginning silence before the keyword, and an end node stores an end silence after the keyword.

10. The speech recognition system of claim 8, wherein the history information includes keyword alignment information generated based on the timestamps of the nodes.

11. The speech recognition system of claim 9, wherein the decoder is configured to derive an exact keyword score by an equation:
S_{ex_kw}=Sₜₒₜₐₗ−Sₛᵢₗ₁−Sₛᵢₗ₂
where S_{ex_kw} represents the exact keyword score, Sₜₒₜₐₗ represents a keyword score, Sₛᵢₗ₁ represents a beginning silence score, and Sₛᵢₗ₂ represents an end silence score.

12. The speech recognition system of claim 11, wherein the decoder is configured to derive a normalized exact keyword score by an equation:
$${S}_{{norm}_{-} kw} = \frac{{S}_{{ex}_{-} kw}}{{D}_{ex \_ kw}}$$
where S_{norm_kw} represents the normalized exact keyword score, S_{ex_kw} represents the exact keyword score, and D_{ex_kw} represents an exact keyword duration.

13. The speech recognition system of claim 11, wherein the decoder is configured to derive an overall normalized SNR score by an equation:
$${S}_{overall \_ norm \_ snr} = \frac{{S}_{ex \_ kw}}{S N {R}_{{avg \_ ex}_{-} kw}}$$
where S_{overall_norm_snr} represents the overall normalized SNR score, S_{ex_kw} represents the exact keyword score, and SNR_{avg_ex_kw} represent an average SNR measured in an exact keyword duration.

14. The speech recognition system of claim 11, wherein the decoder is configured to derive a regional normalized SNR score by an equation:
$${S}_{regional \_ norm \_ snr} = {\sum }_{i} \frac{{S}_{sub - word \_ i}}{S N {R}_{sub - word \_ i}}$$
where S_{regional_norm_snr} represents the regional normalized SNR score, S_{sub-word_i} represents an i-th sub-word unit score, and SNR_{sub-word_i} represents an SNR measured in an i-th sub-word unit duration.

15. The speech recognition system of claim 9, wherein the keyword is segmented into phonemes put into the nodes, but the history information is arranged based on syllables.

16. The speech recognition system of claim 9, wherein the decoder is configured to regard data of the acoustic input as a garbage word when a certain node score of the acoustic input lies in or below a low level.

17. The speech recognition system of claim 9, further comprising an additional full function analyzer connected to the decoder, wherein the decoder is used as a primary stage of decoding, and the additional full function analyzer is used as a secondary stage of decoding.

18. The speech recognition system of claim 17, wherein when a certain node score of the acoustic input lies in or below a medium level, data of the certain node is extracted by the decoder and sent to the additional full function analyzer for detailed analysis.

19. The speech recognition system of claim 1, wherein the speech recognition system is used as an automatic speech recognition (ASR) system or a keyword spotting (KWS) system.

20. The speech recognition system of claim 1, wherein the speech recognition system is implemented in a cloud server or in a local computing device.
